(19) United States
(12) Patent Application Publication
(10) Pub. No.: US 2008/0121057 A1
(43) Pub. Date: May 29, 2008

(54) Device at operating arrangement for operating elongate display members at signs for consecutive, repeated presentation of series of images

(75) Inventor: Anders Janson, Lund (SE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Prismaflex AB

(21) Appl. No.: 11/591,736

(22) Filed: Nov. 2, 2006

(51) Int. Cl. F16H 55/17

(52) U.S. Cl. 74/412 R

(57) ABSTRACT

The present invention relates to a device at an operating arrangement (4) for driving or operating elongate display members (2) at signs (1) for consecutive, repeated presentation of series of images. In order to present a device which provides an optimum initial driving engagement between a gear sector (14) of a driving gear wheel (9) and a driven gear wheel (10) of the operating arrangement (4), the driven gear wheel (10) comprises at least two portions (15) which facilitate bringing along of said driven gear wheel (10) for rotation thereof and which are located such that each time the gear sector (14) during rotation begins to mesh with the driven gear wheel (10), this occurs through one of these portions (15).

### BACKGROUND OF THE INVENTION

The present invention relates to a device at an operating arrangement for operating elongate display members at signs for consecutive, repeated presentation of series of images according to the preamble of claim 1.

By means of the operating arrangement of SE, B, 466 576 it is ensured that one can use a driving motor which during the entire time of display rotates the drive shaft of the operating arrangement continuously in one direction of rotation, i.e. completely without constantly starting and stopping the motor. It is also ensured that the display members can be blocked against rotation and not dislodged when standing still in their display positions. It will further be possible to operate the driving motor in the opposite direction if one wishes to rotate the display members in this opposite direction and the display members are even now prevented from being dislodged when they stand still.

By means of the operating arrangement of SE, B, 512 130, the precision in and the effects of the locking function and thus, the function preventing dislodgement of the elongate display members of the operating arrangement of SE, B, 466 576, is improved. Furthermore, the operating arrangement is optimized for preventing displacement of the gear sector of the driving gear wheel and the driven gear wheel relative to each other in the longitudinal direction of the drive shaft and thus, deteriorate the driving engagement or mesh between the gear wheels, which also might lead to dislodgement of the elongate display members.

Hitherto however, there has not existed any device at operating arrangements of the above type which improves the driving engagement or mesh of the gear sector of the driving gear wheel with the driven gear wheel when this driving engagement is initiated, i.e. in the beginning of said driving engagement between said gear sector and said driven gear wheel, such that rotation of the driven gear wheel is facilitated and the elongate display members thereby are prevented from being displaced relative to each other.

### SUMMARY OF THE INVENTION

The object of the present invention is consequently to present a device which provides an optimum initial driving engagement between the gear sector of the driving gear wheel and the driven gear wheel.

This object is arrived at according to the invention by providing said device with the characterizing features of claim 1.

It has been noticed at e.g. said prior art operating arrangements that certain teeth on the driven gear wheel and the gaps on both sides of each of said teeth are never in driving engagement with the gear sector of the driving gear wheel. Said portions for the abovementioned object can therefore be provided at the location of said teeth and gaps without adversely affecting the function of the operating arrangement.

The above and other characterizing features of the invention as well as the advantages therewith will be further described below with reference to the accompanying drawings.

### DESCRIPTION OF THE DRAWINGS

FIG. 1 is a schematic front view of a part of an operating arrangement for a sign for consecutive, repeated presentation of series of images and provided with a device according to the invention just before driving engagement.

FIG. 2 is a schematic front view similar to FIG. 1 after driving engagement.

FIG. 3 is an enlarged perspective view of the driven gear wheel forming part of the operating arrangement of FIG. 1 and 2 and provided with the device according to the invention.

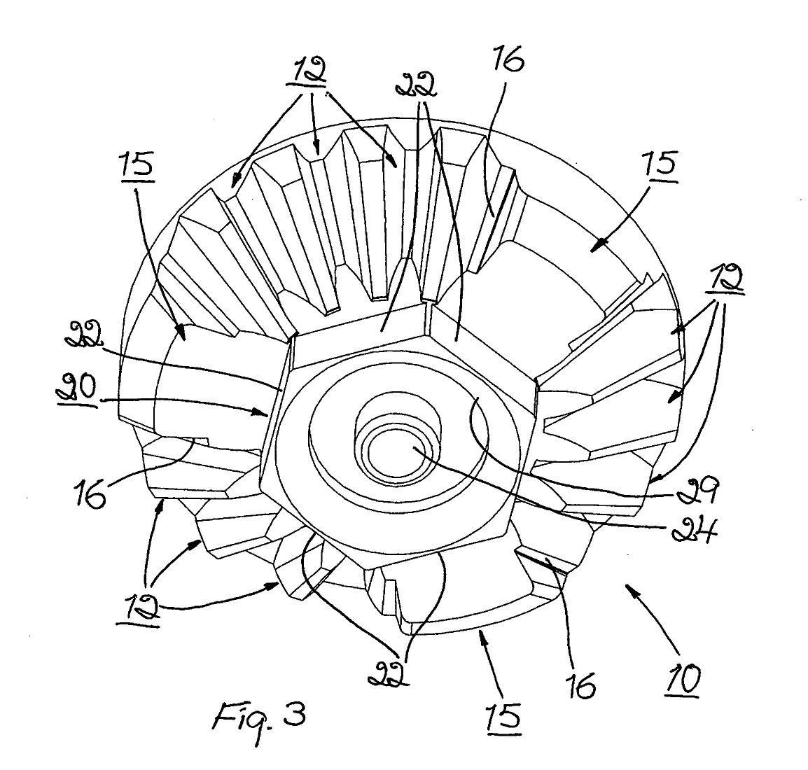

### DETAILED DESCRIPTION OF A PREFERRED EMBODIMENT OF THE INVENTION

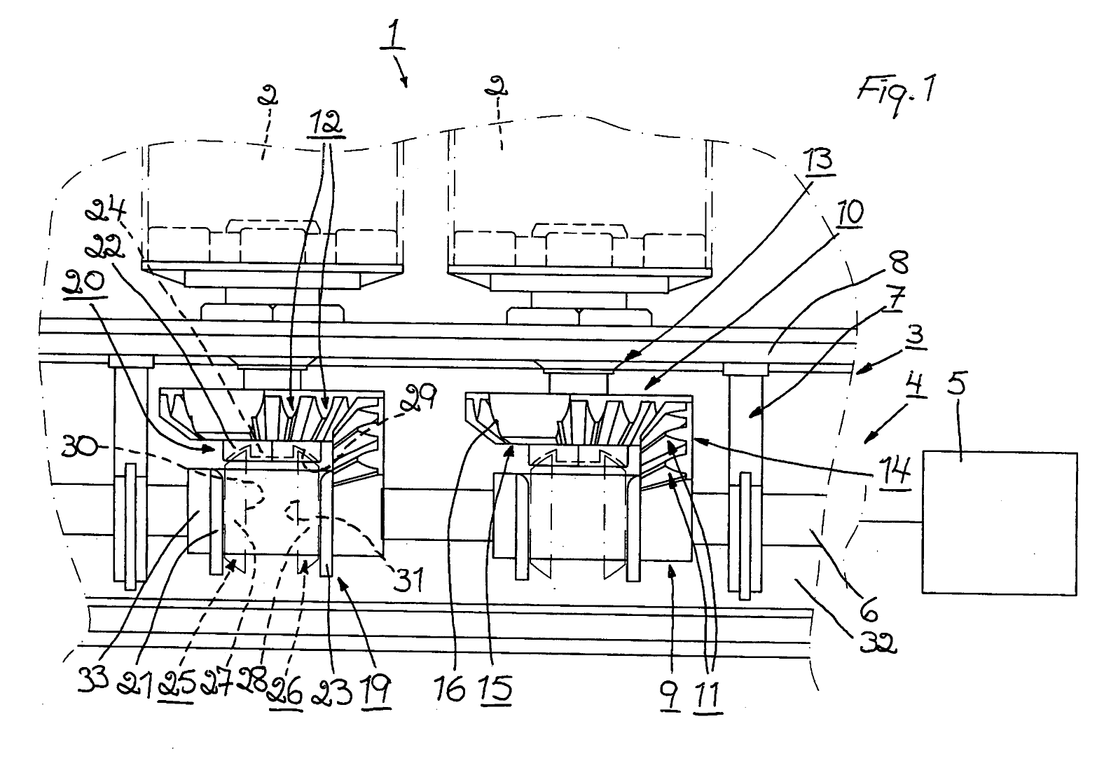

FIG. 1 illustrates a part of an operating arrangement for a sign 1 for consecutive, repeated presentation of series of images, wherein all elongate display members 2 forming part of the sign are rotated either simultaneously for obtaining an effect where said display members at the same moment together define an image or wherein one starts to rotate one or more display members 2 in any part of the sign 1, whereafter successive display members located after each other are rotated for providing a successively growing or “rolling” sign 1.

Said sign 1 comprises a four side frame consisting of frame members of which only a lower frame member 3 is shown in FIG. 1. Essential parts of the operating arrangement 4 is built into this lower frame member 3 and the elongate display members 2 are down below pivotally journalled in said frame member 3. The display members 2 are also, at the top, pivotally journalled in an upper frame member of said four side frame.

In the embodiment shown, the elongated display members 2 are trilateral and the sign 1 is functioning such that a first side of all display members 2 together define an image, a second side of all display members together define a second image and a third side of all display members together define a third image. Said images are shown for a predetermined period of time depending on how long the display members stand still between successive images.

The operating arrangement 4 comprises a driving unit 5, preferably an electric motor, schematically illustrated in FIG. 1 and mounted in a suitable manner on the frame or the lower frame member 3 thereof. The driving unit 5 operates a drive shaft 6 which is rotatably mounted in a suitable number of bearing elements 7 provided in the lower frame member 3. Each such bearing element 7 is preferably mounted in an upper and a rear shank 8 and 32 respectively, of said lower frame member 3.

For operating each elongate display member 2, the operating arrangement 4 comprises a pair of gear wheels 9, 10 having conical teeth 11 and 12 respectively. One gear wheel of said pair of gear wheels 9, 10 is a driving gear wheel 9 which is non-rotatably mounted on the drive shaft 6 and the gear wheel cooperating therewith is a driven gear wheel 10 which is rotatably mounted in the upper shank 8 of the lower frame member 3 through a suitable bearing 13. The driven gear wheel 10 is operatively connected with the respective elongate display member 2 when this member is placed in operating position in the frame.

The driving gear wheel 9 has a gear sector 14 which occupies only a portion of the periphery of said driving gear wheel, such that said gear wheel 9 engages the driven gear wheel 10 only during a part of a revolution of said driving gear wheel. This means that the driven gear wheel 10 and thereby the associated elongate display member 2 are rotated only during a part of a revolution of the driving gear wheel 9, while said driven gear wheel 10 and associated display member 2 stand still during the remaining part of the revolution of said driving gear wheel 9.

Furthermore, the gear sector 14 of the driving gear wheel 9 preferably occupies such part of the periphery of said driving gear wheel that the driven gear wheel 10 during each revolution on the drive shaft 6 is rotated a number of degrees depending on the number of sides on the elongate display members 2 and/or depending on the number of sides on said display members to be displayed.

According to the invention, the driven gear wheel 10 is provided with at least two portions 15 which facilitate bringing along of said driven gear wheel for rotation thereof and which are located such that each time the gear sector 14 during rotation begins to mesh with the driven gear wheel 10, this occurs through one of these portions. The teeth 11 of the gear sector 14 of the driving gear wheel 9 are thereby prevented from being displaced relative to the teeth 12 of the driven gear wheel 10. The number of said portions 15 which facilitate bringing along of said driven gear wheel 10 for rotation thereof, corresponds e.g. with, i.e. is equal to the number of sides on the elongate display members 2 and/or the number of sides on said elongate display members to be displayed. Since the elongate display members 2 at the illustrated embodiment are trilateral, there are preferably three portions 15 provided on the driven gear wheel 10 and said portions are thereby preferably displaced about 120° relative to each other around said driven gear wheel. Said portions 15 are raised relative to the teeth 12 on the driven gear wheel 10 and each time the gear sector 14 begins to mesh with the driven gear wheel for rotation thereof, one of said portions are brought to cooperate with said gear sector. The mesh or operating engagement is improved because the engaging surfaces are thereby larger. Each raised portion 15 has a side surface 16 which is facing in a direction opposite to the direction of rotation of the gear wheels 9, 10 and which, when the gear sector 14 begins to mesh with the driven gear wheel 10, is contacted by a surface 17 provided on the first tooth 11 of the gear sector 14 and facing in said direction of rotation.

At the illustrated embodiment, each raised portion 15 has a width corresponding substantially with the width of a tooth 12 on the driven gear wheel 10 and the width of the gaps adjacent said tooth. The space between two adjacent raised portions 15 corresponds substantially with the width of the gear sector 14. Furthermore, said raised portions 15 are substantially higher and at the most twice as high as the teeth 12 on the driven gear wheel 10.

In order to ensure that the driven gear wheel 10 and associated elongate display member 2 are not dislodged during rotation or when standing still, the drive shaft 6 has a lock means 19 which is provided to cooperate with a member 20, centered with the driven gear wheel 10 and non-rotatably connected therewith, in such a manner that the driven gear wheel is blocked against rotation during that part of a revolution of the driving gear wheel 9 the said gear sector 14 of said driving gear wheel is not engaging the teeth 12 of the driven gear wheel.

The lock means 19 is preferably provided to block the driven gear wheel 10 against rotation when said driven gear wheel is rotated a part of a revolution by the driving gear wheel 9. Since the illustrated elongate display members 2 are trilateral and thus shall stand still three times during each revolution, the lock means 19 is in this embodiment provided to block the driven gear wheel 10 three times during each revolution, namely first in a first position and thereafter in a second position when the driving gear wheel 9 has rotated the driven gear wheel 120° and then again in a third position when said driving gear wheel has rotated said driven gear wheel another 120°.

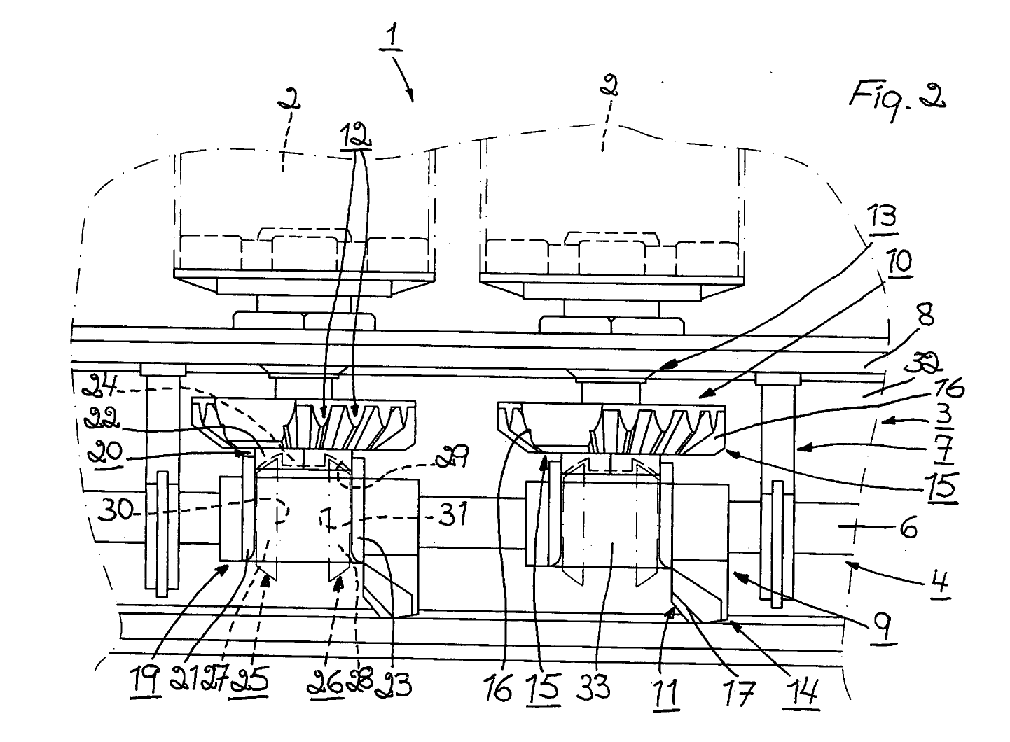

In the embodiment shown, the lock means 19 includes a first lock means member comprising cam disks 21, 23 which are non-rotatably mounted on the drive shaft 6 and protrude therefrom in radial direction. The member 20 non-rotatably connected with the driven gear wheel 10 has a number of side surfaces 22 for cooperation with the cam disks 21, 23. The number of side surfaces 22 on said member 20 corresponds with the number of sides on the elongate display members 2 or is an integer multiple of the number of sides on said display members. In the drawing, said member 20 has six side surfaces 22. The cam disks 21, 23 are located on opposite sides of the member 20 non-rotatably connected with the driven gear wheel 10 and cooperate in locking position with diametrically opposed side surfaces 22 thereon (see FIG. 2), such that the driven gear wheel is blocked against rotation from two sides. At the same time, it is achieved that the gear sector 14 of the driving gear wheel 9 and the driven gear wheel 10 are held in a position preventing displacement thereof relative to each other in the longitudinal direction of the drive shaft 6. With the cam disks 21, 23 in locking position, the gear sector 14 of the driving gear wheel 9 is located in free or neutral position. On the other hand, the cam disks 21, 23 are located in free or neutral position (FIG. 1) when the gear sector 14 of the driving gear wheel 9 is in driving position.

Portions of the cam disks 21, 23 are lacking along that part of the periphery of the driving gear wheel 9 which is occupied by the gear sector 14 or the cam disks 21, 23 are designed e.g. thinner along said part of the periphery of the driving gear wheel such that rotation of the driven gear wheel 10 is allowed without the member 20 non-rotatably connected with the driven gear wheel coming in contact with said cam disks.

At the illustrated embodiment, a guide pin 24 is located centered on the underside of the member 20 non-rotatably connected with the driven gear wheel 10. The guide pin 24 is guided by a second lock means member comprising two guide flanges 25, 26 protruding radially from the drive shaft 6 at a distance from each other and such that the gear sector 14 of the driving gear wheel 9 and the driven gear wheel 10 are constantly held in a position preventing displacement thereof relative to each other in the longitudinal direction of the drive shaft 6, i.e. also when the gear wheels 9, 10 engage each other for rotation of the elongate display members 2. Since the gear wheels 9, 10 are prevented from displacement relative to each other as defined, the driving engagement between said gear wheels remains at an optimum.

The guide flanges 25, 26 have convexly curved, preferably substantially semi-spherical surfaces 27 and 28 respectively, facing away from each other and extending around the drive shaft. These surfaces 27, 28 both cooperate with a substantially semi-spherical, downwards towards the drive shaft 6 open recess 29 which is centered on the underside of the member 20 non-rotatably connected with the driven gear wheel 10. It is hereby achieved, by means of the semi-spherical surfaces 27, 28 engaging the surface of the recess 29 in opposite directions along the longitudinal direction of the drive shaft 6, that the gear sector 14 of the driving gear wheel 9 and the driven gear wheel 10 also during rotation of the elongate display members 2 are prevented from relative displacement thereof. With a guide pin 24 in the centre of the underside of said non-rotatable member 20 and thus, also in the centre of said recess 29, the guide pin is, as mentioned above, located between the guide flanges 25, 26 and cooperate with vertical sides 30 and 31 respectively, of the guide flanges, perpendicular to the drive shaft 6 and facing each other.

The gear sector 14 of the driving gear wheel 9 and the cam disks 21, 23 may be made in one piece with the guide flanges 25, 26. Alternatively, said members may be made in two pieces which are connected to each other e.g. by means of a snap-in closure. Thus, the gear sector 14 may be made in one piece with a first tubular member (not shown) which is provided on the drive shaft 6, while the cam disks 21, 23 and guide flanges 25, 26 are made in one piece with a second tubular member 33 which is threaded onto said first tubular member and connected thereto by a snap-in closure.

The gear sector 14 of the driving gear wheel 9 and the cam disks 21, 23 are driven through the drive shaft 6 together with the guide flanges 25, 26 in one or the opposite direction of rotation or alternately in both directions of rotation for corresponding operation of the elongate display members 2 for consecutive, repeated presentation of series of images.

The device and operating arrangement described above may besides what is stated above vary within the scope of the subsequent claims regarding its location and the design of the members forming part thereof. As examples of alternative designs of the operating arrangement, it should be mentioned that the number of teeth on gear sector 14 and on the driven gear wheel 10 may be another than shown. Also, the device and operating arrangement may be used for elongate display members 2 with another number of sides than three and it may be located in other ways than in a frame member as illustrated in the drawings. Furthermore, the elongate display members need not be vertically oriented, but may instead be horizontally located.

1. Device at operating arrangement (4) for driving or operating elongate display members (2) at signs (1) for consecutive, repeated presentation of series of images, wherein:
the elongate display members (2) are operated through pairs of gear wheels (9, 10), the gear wheels (9, 10) of which have conical teeth (11 and 12 respectively),
a driving gear wheel (9) in each pair of gear wheels is mounted on a drive shaft (6) and a driven gear wheel (10) in each pair of gear wheels is operatively connected with the elongate display members (2) to be operated, and
the driving gear wheel (9) has a gear sector (14) which occupies such a portion of the periphery of said driving gear wheel (9) that said driving gear wheel (9) during each revolution of the drive shaft (6) is rotated a number of degrees depending on the number of sides on the elongate display members (2) and/or depending on the number of sides on said display members (2) to be displayed,
the driven gear wheel (10) comprises at least two portions (15) which facilitate bringing along of said driven gear wheel (10) for rotation thereof and which are located such that each time the gear sector (14) during rotation begins to mesh with the driven gear wheel (10), this occurs through one of these portions (15).

2. Device according to claim 1, wherein the driven gear wheel (10) comprises a number of said portions (15) which corresponds with the number of sides on the elongate display members (2) and/or the number of sides on said elongate display members (2) to be displayed, and that said portions (15) are raised relative to the teeth (12) on the driven gear wheel (10).

3. Device according to claim 2, wherein the driven gear wheel (10) comprises three raised portions (15) and that said raised portions (15) are displaced about 120° relative to each other around said driven gearwheel (10).

4. Device according to claim 2, wherein each raised portion (15) has a side surface (16) which is facing in a direction opposite to the direction of rotation of the gear wheels (9, 10) and which, when the gear sector (14) begins to mesh with the driven gear wheel (10), is contacted by a surface (17) provided on the first tooth (11) of the gear sector (14) and facing in said direction of rotation.

5. Device according to claim 2, wherein each raised portion (15) has a width corresponding substantially with the width of a tooth (12) on the driven gear wheel (10) and the width of the gaps adjacent said tooth.

6. Device according to claim 2, wherein the space between two adjacent raised portions (15) corresponds substantially with the width of the gear sector (14).

7. Device according to claim 2, wherein said raised portions (15) are substantially higher and at the most twice as high as the teeth (12) on the driven gear wheel (10).

8. Device according to claim 1, wherein the driven gearwheel (10) further comprises a member (20) which is centered with the driven gear wheel (10) and non-rotatably connected therewith and which cooperates with a lock means (19) on the drive shaft (6) which is provided to be located in a locking position for blocking the driven gear wheel (10) against rotation immediately after the gear sector (14) of the driving gear wheel (9) is no longer engaging or meshing with the driven gear wheel (10), and leaving its locking position for permitting rotation of the driven gear wheel (10) just before the gear sector (14) of the driving gear wheel (9) engages or meshes with the driven gearwheel (10).

9. Device according to claim 8, wherein:
the member (20) non-rotatably connected with the driven gear wheel (10) has a number of side surfaces (22) for cooperation with a first member of the lock means (19), said first lock means member comprising two cam disks (21, 23) which protrude radially from the drive shaft (6),
the number of side surfaces (22) on the member (20) non-rotatably connected with the driven gear wheel (10) corresponds with the number of sides on the elongate display members (2) alternatively is an integer multiple thereof, and
the cam disks (21, 23) are located on opposite sides of the member (20) non-rotatably connected with the driven gear wheel (10) and cooperate in the locking position with diametrically opposed side surfaces (22) thereon, such that the driven gear wheel (10) is blocked against rotation from two sides while at the same time the gear sector (14) of the driving gear wheel (9) and the driven gear wheel (10) are held in a position preventing displacement thereof relative to each other in the longitudinal direction of the drive shaft (6).

10. Device according to claim 9, wherein portions of the cam disks (21, 23) are lacking along that part of the periphery of the driving gear wheel (9) which is occupied by the gear sector (14) or are the cam disks (21, 23) designed e.g. thinner along said part of the periphery of the driving gear wheel (9) such that rotation of the driven gear wheel (10) is allowed without the member (20) non-rotatably connected with the driven gear wheel (10) coming in contact with the cam disks (17, 23).

11. Device according to claim 8, wherein:
the member (20) non-rotatably connected with the driven gear wheel (10) has a substantially semi-spherical, downwards towards the drive shaft (6) open recess (29) which is centered on the underside of said member (20),
a second member of the lock means (19) comprises two guide flanges (25, 26) which protrude radially from the drive shaft (6) at a distance from each other, and
the guide flanges (25, 26) have convexly curved, preferably substantially semi-spherical surfaces (27 and 28 respectively), facing away from each other and extending around the drive shaft (6), for cooperation with said recess (29) such that the gear sector (14) of the driving gear wheel (9) and the driven gear wheel (10) are held in a position preventing relative displacement thereof in the longitudinal direction of the drive shaft (6).

12. Device according to claim 11, wherein:
a guide pin (24) is centered in the recess (29) on the underside of the member (20) non-rotatably connected with the driven gear wheel (10), and
the two guide flanges (25, 26) also have vertical sides (30 and 31 respectively), extending perpendicular to the drive shaft (6) and facing each other, for cooperation with said guide pin (24) such that the gear sector (14) of the driving gear wheel (9) and the driven gear wheel (10) are held in a position preventing relative displacement thereof in the longitudinal direction of the drive shaft (6).

13. Device according to claim 8, wherein the gear sector (14) of the driving gear wheel (9) and the cam disks (21, 23) are driven through the drive shaft (6) together with the guide flanges (25, 26) in one or the opposite direction of rotation or alternately in both directions of rotation for corresponding operation of the elongate display members (2) for consecutive, repeated presentation of series of images.

14. Device according to claim 8, wherein the gear sector (14) of the driving gear wheel (9), the cam disks (21, 23) and the guide flanges (25, 26) are made in one piece.

15. Device according to claim 8, wherein the gear sector (14) of the driving gear wheel (9), the cam disks (21, 23) and the guide flanges (25, 26) are made in two pieces which are connected to each other by a snap-in closure.
